(19) United States
(12) Patent Application Publication
(10) Pub. No.: US 2021/0360874 A1
(43) Pub. Date: Nov. 25, 2021

(54) Hollow Plastic Garden Blocks

(71) Applicant: JOHN SAMUEL JARMOSKI, MORGANTOWN, PA (US)

(72) Inventor: JOHN SAMUEL JARMOSKI, MORGANTOWN, PA (US)

(21) Appl. No.: 16/870,925

(22) Filed: May 25, 2020

(51) Int. Cl. A01G 9/28; A01G 9/02

(52) U.S. Cl. CPC A01G 9/28; A01G 9/02

(57) ABSTRACT

This invention titled ‘Hollow Plastic Garden Blocks’ provides a new and convenient construction material for the home gardener. The blocks can be stacked or placed side by side to construct raised beds, or living walls, or used as garden bed edging. Unlike traditional cement wall blocks, the hollow plastic blocks are very lightweight and easily transported or moved by the home gardener. The blocks can be filled with soil or a suitable planting medium and then seeded or populated with living plants. These blocks are not restricted by interlocking positions therefore offer complete freedom of linear shape alignment. All blocks have drainage holes for greater durability. Any standard and efficient method of plastic shape fabrication could be used to produce these blocks. The blocks can be made of any durable plastic, virgin or recycled, and color choices are unlimited.

The Hollow Plastic Garden Blocks are a collection of shapes that allow the home gardener to construct raised beds, living walls or borders for planting beds using lightweight, fillable blocks.

### INDEX OF DRAWINGS

FIG. 1. Small Wall Block: FIG. 1—isometric top view, FIG. 2—wire frame isometric top view, FIG. 3—isometric bottom view

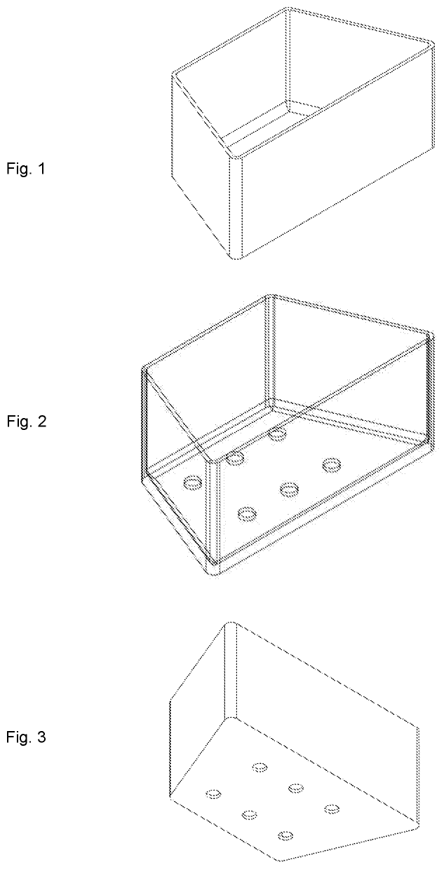

FIG. 2. Small Corner Block: FIG. 4—isometric top view, FIG. 5—wire frame isometric top view, FIG. 6—isometric bottom view

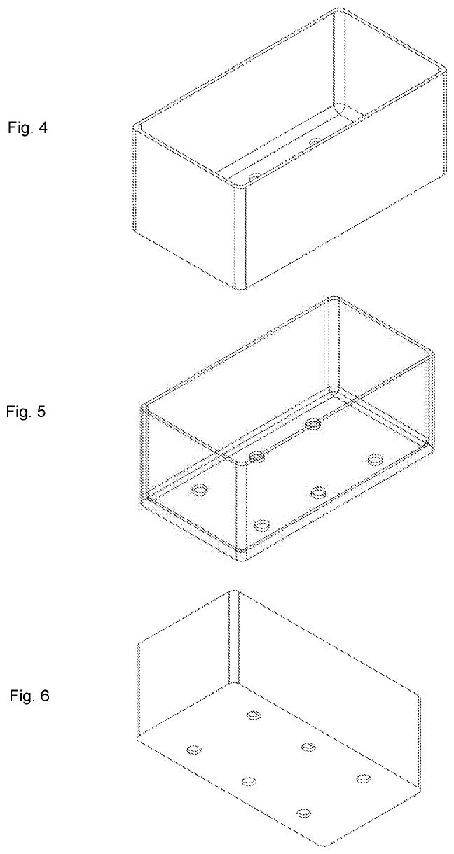

FIG. 3. Large Wall Block: FIG. 7—isometric top view, FIG. 8—wire frame isometric top view, FIG. 9—isometric bottom view

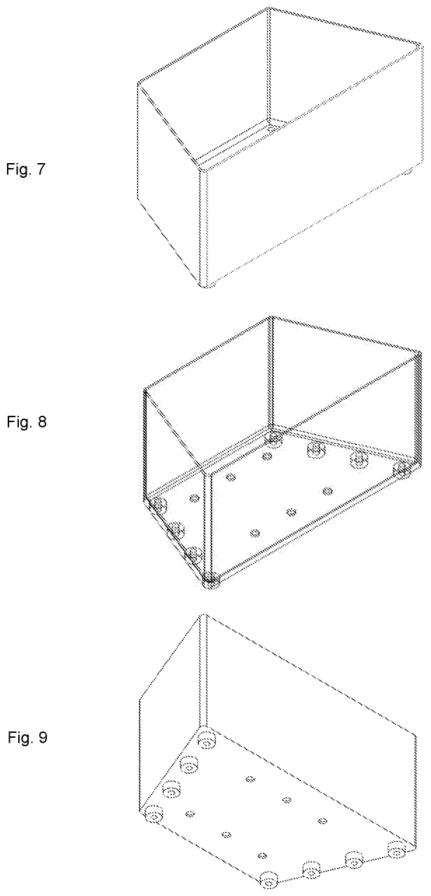

FIG. 4. Large Corner Block: FIG. 10—isometric top view, FIG. 11—wire frame isometric top view, FIG. 12—isometric bottom view

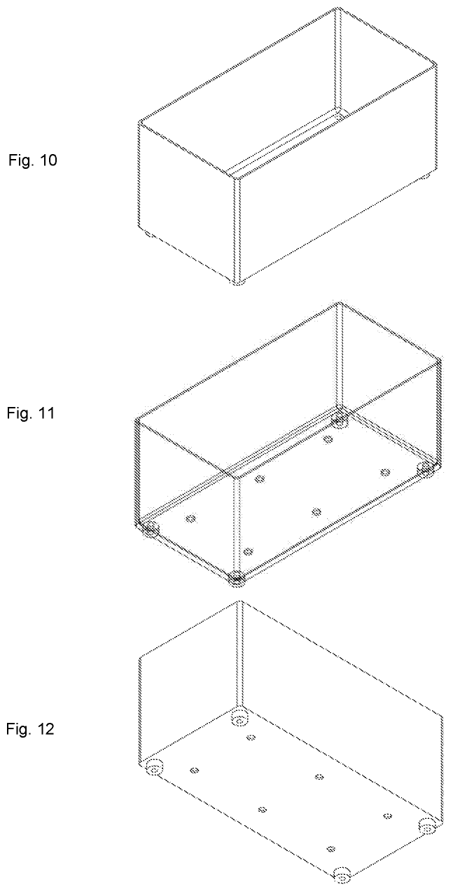

FIG. 5. Extra Large Wall Block: FIG. 13—isometric top view, FIG. 14—wire frame isometric top view, FIG. 15—isometric bottom view

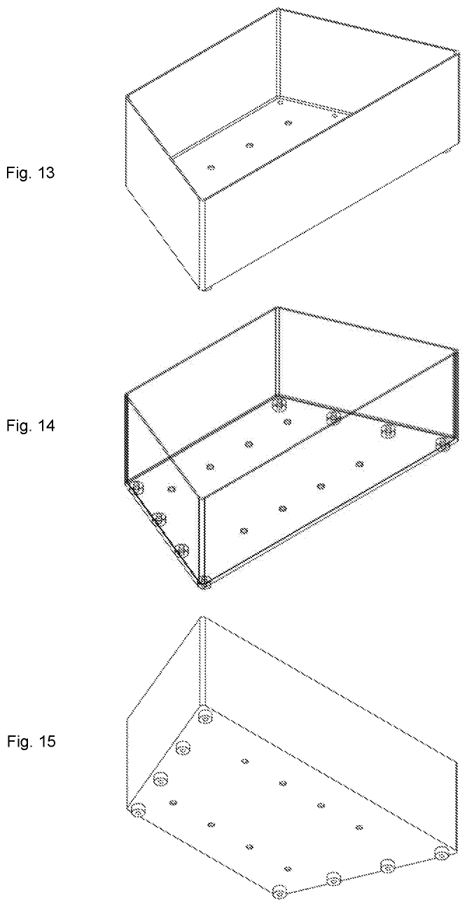

### DETAILED DESCRIPTION

The Hollow Plastic Garden Blocks allow the home gardener to construct raised beds, living walls, or planting bed borders. The blocks are essentially specialty flower pots, and they are light and easy to transport. Three sizes of wall blocks allow for construction of curved walls to follow the contours of varied terrain. These are in the shape of tetrahedrons when viewed from above. The wall blocks can be assembled closely to form an octagon or circular shape. The Extra Large Blocks, in addition to wall building, can be used as stair steps in conjunction with the Large Blocks. All blocks can be filled with a planting medium, and with plants, to form living walls. All blocks also have drainage holes. The corner blocks enable the construction of square wall corners. Except for the small wall and small corner blocks, all blocks have feet which can make any structure more stable in areas that are subject to frost heaving. All blocks can also serve as bed edging and can be used at ground level or partially submerged to define a bed. The blocks can also provide the basis for a more structural wall. The blocks can be filled with any soil found on site, or any soil or gravel, sold and delivered by landscape suppliers. For the ultimate structural wall, the blocks can be pinned through the drainage holes, using rebar or landscape spikes. A geogrid material could be incorporated for additional stability. The blocks could also be filled with cement for extreme stability.

The manufacturing of the blocks could be by injection molding or by vacuum forming, using a strong UV resistant plastic. The color of the blocks could be varied to meet consumer demand. Black, brown, green and brick red are primary choices but also tan, grey, white, or a marbled look are possible color options.

### DISCLOSURE

The Hollow Plastic Garden Blocks provide a new method of building raised beds, walls, and borders, for the home gardener. This is a departure from using heavy cement blocks or timbers for home garden construction.

### DECLARATION

I/John Samuel Jarmoski/a citizen of The United States of America, believe that I am the original inventor of this hollow plastic block system designed for use in home garden construction.

1. The invention claimed, Hollow Plastic Garden Blocks, comprising: a collection of five lightweight blocks with different shapes and sizes, which can be arraigned to form garden structures such as walls, raised beds, or bed edging, and then filled with vegetation to create living structures.
